(19) United States
(12) Patent Application Publication
(10) Pub. No.: US 2023/0019506 A1
(43) Pub. Date: Jan. 19, 2023

(54) ELECTROLYTE COMPOSITION WITH FLUORINATED ACYCLIC CARBONATE AND FLUORINATED CYCLIC CARBONATE

(71) Applicant: Solvay SA, Brussels (BE)

(72) Inventors: Hyun-Cheol Lee, Suwon-city (KR); Hyung-Kwon Hwang, Seoul (KR); Eun-Ji Moon, Seoul (KR); Du-Hyun Won, Cheongju-si (KR); Lawrence Alan Hough, Seoul (KR); Jong-Hyun Lee, Goyang-si (KR)

(73) Assignee: Solvay SA, Brussels (BE)

(21) Appl. No.: 17/781,707

(22) PCT Filed: Nov. 13, 2020
(86) PCT No.: PCT/EP2020/082011

§ 371 Date: Jun. 2, 2022

(30) Foreign Application Priority Data
Dec. 3, 2019 (EP) 19213036.7

(51) Int. Cl. H01M 4/36; H01M 4/38; H01M 10/0525; H01M 4/583; H01M 10/0569; H01M 10/0567; H01M 10/0568

(52) U.S. Cl. CPC H01M 4/364; H01M 4/386; H01M 10/0525; H01M 4/583; H01M 10/0569; H01M 10/0567; H01M 10/0568; H01M 2004/027

(57) ABSTRACT

An electrochemical cell comprises an anode, a cathode and an electrolyte composition, wherein the anode comprises as anode active material a combination of at least a carbon material and a silicon material; and the electrolyte composition comprises a solvent, from 0.5 wt. % to 70 wt. %, based on the total weight of the electrolyte, of a fluorinated acyclic carbonate compound, from 0.5 wt. % to 10 wt. %, based on the total weight of the electrolyte, of a fluorinated cyclic carbonate compound; and an electrolyte salt.

### CROSS-REFERENCE TO RELATED APPLICATION

This application claims priority to European patent application No. 19213036.7 filed on Dec. 3, 2019, the whole content of this application being incorporated herein by reference for all purposes.

### TECHNICAL FIELD

The present invention relates to an electrolyte composition comprising a combination of a fluorinated acyclic carbonate compound, and a fluorinated cyclic carbonate compound.

This electrolyte composition is useful in electrochemical cells, such as lithium ion batteries, especially those containing silicon and its derivatives as an anode material.

### BACKGROUND ART

Lithium-ion batteries are a leading battery technology, since they offer efficient and high energy storage as well as high power density, and thus, they dominate the market for batteries used in portable electronic devices. However, large-scale applications like stationary energy storage and electric vehicles still require further improvement of the existing technology in terms of energy density, supplied power and cycle life.

The use of silicon as an anode material for lithium ion batteries has attracted tremendous attention because of its high theoretical specific capacity (3580 mAh/g, nearly ten times higher than the typical graphite anode material, 372 mAh/g), appropriate lithium intercalation voltage and cost competency. One drawback of silicon as anode material is its large volume expansion during cycling (more than 300%), which causes cracking and pulverization of silicon particles resulting in sluggish kinetics and a poor cycle life because of the loss of active material and poor electrical contact.

The use of silicon in a composite with other elements leads to a composite material showing lower anode capacity values than using pure silicon alone, but it shows better capacity retention with good cycle life. Representative silicon composite materials are silicon-carbon (Si/C) and silicon oxide-carbon (SiOₐ/C, wherein 0<a<2). Carbon can be regarded as a diluent/buffer which mitigates the total volume expansion of the silicon composite material. This solution has gained a lot of popularity among researchers and battery manufacturers.

The use of fluoroethylene carbonate (FEC) as an electrolyte component introduced to carbon coated porous Si anodes has been reported by Myung-Jin Chun, Hyungmin Park, Soojin Park and Nam-Soon Choi, RSC Adv., 2013, 3, 21320. Cycling performance at temperatures of 30° C. and 60° C. was improved. However, FEC decomposes more rapidly at temperatures above ambient temperature. The first consequence is that the addition of FEC is not efficient enough for improving high temperature cycling. The second consequence is that FEC generates gases when decomposing that could create a swelling issue.

Thus, it is highly desirable to provide an electrolyte composition that will improve the cycle performance of a lithium ion battery, especially a lithium ion battery containing silicon carbon composite as an anode material. A technological need is the improvement of the cycle performance at high temperature (typically 45° C.) while maintaining the cycle performance at ambient temperature (typically 25° C.) should be maintained.

### BRIEF DESCRIPTION OF THE INVENTION

One subject-matter of the invention is an electrochemical cell comprising an anode, a cathode and an electrolyte composition, wherein said anode comprises as an anode active material a combination of at least a carbon material and a silicon material; and said electrolyte composition comprises:
a solvent;
from 0.5 wt. % to 70 wt. %, based on the total weight of the electrolyte, of a fluorinated acyclic carbonate compound of general formula

R¹—OCOO—R²

wherein R¹ is a C1-C4 alkyl group, and R² is C1-C4 fluoroalkyl group,
from 0.5 wt. % to 10 wt. %, based on the total weight of the electrolyte, of a fluorinated cyclic carbonate compound; and
an electrolyte salt.

In another aspect, there is disclosed an electronic device, transportation device, or telecommunications device, comprising an electrochemical cell as defined above.

In addition, another subject-matter of the present invention is the use of a combination of:
from 0.5 wt. % to 70 wt. %, based on the total weight of the electrolyte, of a fluorinated acyclic carbonate compound of general formula

R¹—OCOO—R²

wherein R¹ is a C1-C4 alkyl group, and R² is C1-C4 fluoroalkyl group,
from 0.5 wt. % to 10 wt. %, based on the total weight of the electrolyte, of a fluorinated cyclic carbonate compound,
as an additive in an electrolyte composition, to improve the cycling performance at high temperature of an electrochemical cell comprising, as an anode active material, a combination of at least a carbon material and a silicon material.

### BRIEF DESCRIPTION OF THE FIGURE(S)

FIG. 1 shows the cycling performance (discharge capacity and capacity retention) of the cells containing the electrolyte formulations of the examples at room temperature (25° C.).

FIG. 2 shows the cycling performance (discharge capacity and capacity retention) of the cells containing the electrolyte formulations of the examples at high temperature (45° C.).

FIG. 3 shows the capacity retention and the capacity recovery after storage at 60° C. of the cells according to the examples.

### DESCRIPTION OF THE INVENTION

The term “alkyl group”, as used herein and except otherwise specified, refers to linear or branched, straight or cyclic hydrocarbon groups containing from 1 to 20 carbons, preferably from 1 to 6 carbons, more preferably from 1 to 4 carbons, and containing no unsaturation. Examples of straight chain alkyl radicals include methyl, ethyl, propyl, butyl, pentyl, hexyl, heptyl, octyl, nonyl, decyl, undecyl, and dodecyl. Examples of branched chain isomers of straight chain alkyl groups include isopropyl, iso-butyl, tert-butyl, sec-butyl, isopentyl, neopentyl, isohexyl, neohexyl, and isooctyl. Examples of cyclic alkyl groups include cyclopropyl, cyclobutyl, cyclopentyl, cyclohexyl, cycloheptyl, and cyclooctyl.

The term “fluoroalkyl group”, as used herein and except otherwise specified, refers to an alkyl group wherein at least one hydrogen is replaced by fluorine.

The term “alkenyl group”, as used herein and except otherwise specified, refers to linear or branched, straight or cyclic groups as described with respect to alkyl group as defined herein, except that at least one double bond exists between two carbon atoms. Examples of alkenyl groups include vinyl, cyclohexenyl, cyclopentenyl, cyclohexadienyl, and butadienyl.

The term “alkynyl group”, as used herein and except otherwise specified, refers to linear or branched, straight or cyclic groups as described with respect to alkyl group as defined herein, except that at least one triple bond exists between two carbon atoms.

Unless otherwise specified, all percentages are percentages by weight and are based on the total weight of the electrolyte composition.

The equilibrium potential between lithium and lithium ion is the potential of a reference electrode using lithium metal in contact with the electrolyte composition containing lithium salt at a concentration sufficient to give about 1 mole/liter of lithium ion concentration, and subjected to sufficiently small currents so that the potential of the reference electrode is not significantly altered from its equilibrium value (Li/Li⁺). The potential of such a Li/Li⁺ reference electrode is assigned here the value of 0.0V. Potential of an anode or cathode means the potential difference between the anode or cathode and that of a Li/Li⁺ reference electrode. Herein voltage means the voltage difference between the cathode and the anode of a cell, neither electrode of which may be operating at a potential of 0.0V.

The term “SEI”, as used herein, refers to a solid electrolyte interphase layer formed on the active material of an electrode. A lithium-ion secondary electrochemical cell is assembled in an uncharged state and must be charged (a process called formation) for use. During the first few charging events (battery formation) of a lithium-ion secondary electrochemical cell, components of the electrolyte are reduced or otherwise decomposed or incorporated onto the surface of the negative active material and oxidized or otherwise decomposed or incorporated onto the surface of the positive active material, electrochemically forming a solid-electrolyte interphase on the active materials. These layers, which are electrically insulating but ionically conducting, help prevent decomposition of the electrolyte and can extend the cycle life and improve the performance of the battery. On the anode, the SEI can suppress the reductive decomposition of the electrolyte; on the cathode, the SEI can suppress the oxidation of the electrolyte components.

One subject-matter of the invention is an electrochemical cell comprising an anode, a cathode and an electrolyte composition.

The term “electrochemical cell” refers to the basic functional unit that is a source of electric energy obtained by direct conversion of chemical energy. Typically, the electrochemical cell may comprise or consist of a housing, an anode and a cathode disposed in the housing and in ionically conductive contact with one another, an electrolyte composition disposed in the housing and providing an ionically conductive pathway between the anode and the cathode; and a porous separator between the anode and the cathode.

In a preferred embodiment, the electrochemical cell is a lithium ion battery.

The term “lithium ion battery” refers to a type of rechargeable battery in which lithium ions move from the anode to the cathode during discharge and from the cathode to the anode during charge.

The housing may be any suitable container to house the electrochemical cell components. Housing materials are well-known in the art and can include, for example, metal and polymeric housings. While the shape of the housings is not particularly important, suitable housings can be fabricated in the shape of a cylinder, a prismatic case or a pouch.

The porous separator serves to prevent short circuiting between the anode and the cathode. The porous separator typically consists of a single-ply or multi-ply sheet of a microporous material such as polyethylene, polypropylene, polyamide, polyimide, glass fiber, non-woven cellulous or a combination thereof. Porous systems can be coated with a ceramic or polymer layer. The pore size of the porous separator is sufficiently large to permit transport of ions to provide an ionically conductive contact between the anode and cathode, but small enough to prevent contact of the anode and cathode either directly or from particle penetration or dendrites which can form on the anode and cathode.

The term “anode” refers to the electrode of an electrochemical cell, at which oxidation occurs. In a secondary (i.e. rechargeable) battery, the anode is the electrode at which oxidation occurs during discharge and reduction occurs during charging.

According to the present invention, the anode comprises as anode active material a combination of at least a carbon material and a silicon material.

The carbon material (noted “C”) should be able to absorb and desorb lithium ion. The carbon material can be selected from the group consisting of graphite, amorphous carbon, diamond-like carbon, carbon nanotube or a complex thereof. Material typically commercialized for anodes are Mesocarbon Microbead (MCMB), Mesophase-pitch-based carbon fiber (MCF), vapor grown carbon fiber (VGCF) and Massive Artificial Graphite (MAG). Carbon material may preferably consists of between 2 wt. % and 99 wt. % of the anode active material, and more preferably between 2 wt. % and 97 wt. %. Carbon material may consists of either between 2 wt. % and 30 wt. %, or between 30 wt. % and 50 wt. %, or between 50 wt. % and 97 wt. % of the anode active material.

The silicon material should be able to absorb and desorb lithium ion and/or should be able to alloy with lithium. The silicon material may be silicon metal (noted “Si”) or silicon oxide (noted “SiOₐ”, 0<a<2), or mixtures thereof. Silicon metal Si may preferably consists of between 3 wt. % and 90 wt. % of the anode active material, and more preferably between 3 wt. % and 50 wt. %. Silicon metal Si may consists of either between 3 wt. % and 20 wt. %, or between 20 wt. % and 50 wt. %, or between 50 wt. % and 90 wt. % of the anode active material. Silicon oxide SiOₐ (with 0<a<2) may preferably consists of between 3 wt. % and 90 wt. % of the anode active material, and more preferably between 3 wt. % and 50 wt. %. Silicon oxide SiOₐ may consists of either between 3 wt. % and 40 wt. %, or between 40 wt. % and 70 wt. %, or between 70 wt. % and 90 wt. % of the anode active material.

The anode may be a composite material selected from Si/C, SiOₐ/C and Si/SiOₐ/C (0<a<2).

Methods to make such composite materials are based on mixing the individual ingredients (e.g. C and Si and/or SiOₐ, or a precursor for the intended matrix material) during preparation of the electrode paste formulation, or by a separate composite manufacturing step that is then carried out via dry milling/mixing of at least the carbon material and the silicon material (possible followed by a firing step), or via wet milling/mixing of at least the carbon material and the silicon material (followed by removal of the liquid medium and a possible firing step).

In addition to the above-described anode active materials, an anode active material composition in which a binder and a solvent are mixed, may be prepared. Water may be used as a solvent. Carboxymethyl cellulose (CMC), styrene-butadiene rubber (SBR), acrylate, and methacrylate copolymers may be used as a binder. The anode active material composition may further include a conductive agent and/or a filler. Carbon black, acetylene black, and graphite may be used as a conductive agent and/or a filler. For example, 94 wt. % of a anode active material including a Si/C composite material, 3 wt. % of a binder and 3 wt. % of a conductive agent may be mixed in powder form, and water as a solvent is added to prepare a slurry having a solids content of 70 wt. %. Then, the slurry may be coated, dried, and pressed on an anode current collect to prepare an anode electrode plate.

The anode can be produced by forming an anode active material layer containing the anode active material and an anode binder on an anode current collector. The anode current collector is not particularly limited as long as the anode current collector does not cause chemical changes in the battery and has high conductivity. For example, the anode current collector may be formed of copper, stainless steel, aluminum, nickel, titanium, sintered carbon, copper, stainless steel that is surface treated with carbon, nickel, titanium, or silver, or an aluminum-cadmium alloy. Examples of the shape thereof include foil, flat plate and mesh. The anode electrode current collector generally has a thickness of about 3 μm to about 500 μm. Examples of the method of forming the anode active material layer include doctor blade method, die coater method, CVD method, and sputtering method. The anode active material layer may then be dried and pressed, and the anode part of the device may to obtained.

The term “cathode” refers to the electrode of an electrochemical cell, at which reduction occurs. In a secondary (i.e. rechargeable) battery, the cathode is the electrode at which reduction occurs during discharge and oxidation occurs during charging.

In some embodiments, the cathode can include, for example, cathode active materials comprising lithium and transition metals, such as LiCoO₂, LiNiO₂, LiMn₂O₄, LiCo_{0,2} Ni_{0,2}O₂, LiV₃O₈, LiNi_{0,5}Mn_{1,5}O₄, LiFePO₄, LiMnPO₄, LiCoPO₄, LiVPO₄F, LiNi_{1/3}Co_{1/3}Mn_{1/3}O₂, LiNi_{0.5}Co_{0.2}Mn_{0.3}O₂, LiNi_{0.6}Co_{0.2}Mn_{0.2}O₂, LiNi_{0.8}Co_{0.1}Mn_{0.1}O₂ or LiNiₐCo_{b}Mn_{c}O₂ wherein a+b+c=1.

In other embodiments, the cathode active materials can include, for example:

LiₐA_{1-b}R_{b}D₂ (0.90≤a<1.8 and 0≤b<0.5);

LiₐE_{1-b}R_{b}O_{2-c}D_{c} (0.90≤a<1.8, 0≤b<0.5 and 0≤c<0.05);

LiₐCoG_{b}O₂ (0.90≤a<1.8, and 0.001<b<0.1);

LiₐNi_{1-b-c}Co_{b}R_{c}O_{2-d}Z_{d} (where 0.9≤a<1.8, 0≤b<0.4, 0≤c<0.05, and 0≤d<0.05);

Li_{1+z}Ni_{1-x-y}CoₓAl_{y}O₂ (where 0<x<0.3, 0<y<0.1, and 0<z<0.06);

LiₐNi_{b}Mn_{c}Co_{d}RₑO_{2-f}Z_{f} (where 0.8≤a<1.2, 0.1≤b<0.5, 0.2≤c<0.7, 0.05≤d<0.4, 0≤e<0.2, the sum of b+c+d+e is 1, and 0≤f<0.08;

In the above chemical formulas A is Ni, Co, Mn, or a combination thereof; D is O, F, S, P, or a combination thereof; E is Co, Mn, or a combination thereof; G is Al, Cr, Mn, Fe, Mg, La, Ce, Sr, V, or a combination thereof, R is Al, Ni, Co, Mn, Cr, Fe, Mg, Sr, V, Zr, Ti, a rare earth element, or a combination thereof; Z is F, S, P, or a combination thereof.

By “rare earth element” is meant the lanthanide elements from La to Lu, and Y and Sc.

In another embodiment, the cathode active material is a material exhibiting greater than 120 mAh/g capacity in an operation voltage ranging from 3.0V to 4.2V.

The cathode, in which the cathode active material is contained, can be prepared by mixing an effective amount of the cathode active material, for example, about 70 wt. % to about 97 wt. %, with a polymer binder, such as polyvinylidene difluoride (PVdF), and conductive carbon in a suitable solvent, such as N-methylpyrrolidone (NMP), to generate a paste, which is then coated onto a current collector such as aluminum foil, and dried to form the cathode. The percentage by weight is based on the total weight of the cathode.

The electrochemical cell according to the present invention further comprise an electrolyte composition. The term “electrolyte composition” as used herein, refers to a chemical composition which is capable of supplying an electrolyte in an electrochemical cell. The electrolyte cell of the invention comprises at least a solvent, an electrolyte salt, and the combination of:
from 0.5 wt. % to 70 wt. %, based on the total weight of the electrolyte, of a fluorinated acyclic carbonate compound of general formula

R¹—OCOO—R²

wherein R¹ is a C1-C4 alkyl group, and R² is C1-C4 fluoroalkyl group,
from 0.5 wt. % to 10 wt. %, based on the total weight of the electrolyte, of a fluorinated cyclic carbonate compound.

The electrolyte composition according to the present invention comprises a fluorinated acyclic carbonate. Suitable fluorinated acyclic carbonates may be represented by the formula:

R¹—OCOO—R²

wherein R¹ is a C1-C4 alkyl group, and R² is C1-C4 fluoroalkyl group,

In one embodiment, R¹ comprises one carbon atom. In another embodiment, R¹ comprises two carbon atoms. In another embodiment, R¹ and R² are as defined herein above, and R¹ and R², taken as a pair, comprise at least two carbon atoms but not more than seven carbon atoms and further comprise at least two fluorine atoms, with the proviso that neither R¹ nor R² contains a FCH₂— group or a —FCH— group.

Examples of suitable fluorinated acyclic carbonates include without limitation CH₃—OC(O)O—CH₂CF₂H (methyl 2,2-difluoroethyl carbonate, CAS No. 916678-13-2), CH₃—OC(O)O—CH₂CF₃ (methyl 2,2,2-trifluoroethyl carbonate, CAS No. 156783-95-8), CH₃—OC(O)O—CH₂CF₂CF₂H (methyl 2,2,3,3-tetrafluoropropyl carbonate, CAS No. 156783-98-1), CH₃CH₂—OCOO—CH₂CF₂H (ethyl 2,2-difluoroethyl carbonate, CAS No. 916678-14-3), and CH₃CH₂—OCOO—CH₂CF₃ (ethyl 2,2,2-trifluoroethyl carbonate, CAS No. 156783-96-9).

The electrolyte composition according to the present invention may comprise one fluorinated acyclic carbonate as defined above, or a mixture of two or more fluorinated carbonates.

Fluorinated acyclic carbonates suitable for use herein may be prepared using known methods. For example, methyl chloroformate may be reacted with 2,2-difluoroethanol to form methyl 2,2-difluoroethyl carbonate. Alternatively, some of these fluorinated compounds may be purchased from companies such as Matrix Scientific (Columbia S.C.). For best results, it is desirable to purify the fluorinated acyclic carbonates to a purity level of at least about 99.9%, more particularly at least about 99.99%. These fluorinated compounds may be purified using distillation methods such as vacuum distillation or spinning band distillation.

The content of the fluorinated acyclic carbonate compound is from 0.5 wt. % to 70 wt. %, based on the total weight of the electrolyte. According to one embodiment, the content of the fluorinated acyclic carbonate compound is from 10 wt. % to 70 wt. %, preferably from 15 wt. % to 60 wt. %, more preferably from 20 wt. % to 50 wt. %, based on the total weight of the electrolyte. However, lower amounts of the fluorinated acyclic carbonate compound are believed to be advantageous. According to another embodiment, the content of the fluorinated acyclic carbonate compound is from 0.5 wt. % to 10 wt. %, based on the total weight of the electrolyte. Preferably, the content of the fluorinated acyclic carbonate is strictly less than 10%. More preferably, the content of the fluorinated acyclic carbonate is from 1 wt. % to 9 wt. %, even more preferably from 2 wt. % to 5 wt. %.

The electrolyte composition according to the present invention comprises a fluorinated cyclic carbonate. The fluorinated cyclic carbonate may be selected from the group consisting of 4-fluoroethylene carbonate; 4,5-difluoro-1,3-dioxolan-2-one; 4,5-difluoro-4-methyl-1,3-dioxolan-2-one; 4,5-difluoro-4,5-dimethyl-1,3-dioxolan-2-one; 4,4-difluoro-1,3-dioxolan-2-one; 4,4,5-trifluoro-1,3-dioxolan-2-one; tetrafluoroethylene carbonate; and mixtures thereof. 4-Fluoroethylene carbonate is also known as 4-fluoro-1,3-dioxolan-2-one or fluoroethylene carbonate. Preferably, the fluorinated cyclic carbonate may be selected from the group consisting of 4-fluoroethylene carbonate; 4,5-difluoro-1,3-dioxolan-2-one; and mixtures thereof. According to one preferred embodiment, the fluorinated cyclic carbonate compound is fluoroethylene carbonate.

It is desirable to use a fluorinated cyclic carbonate that is battery grade, or has a purity level of at least about 99.9%, and more particularly at least about 99.99%. Such fluorinated cyclic carbonates are typically commercially available.

The content of the fluorinated cyclic carbonate compound is from 0.5 wt. % to 10 wt. %, based on the total weight of the electrolyte. Preferably, the content of the fluorinated cyclic carbonates is strictly less than 10%. More preferably, the content of the fluorinated cyclic carbonates is from 1 wt. % to 9 wt. %, even more preferably from 2 wt. % to 5 wt. %.

The solvent in the electrolyte composition according to the invention may be any appropriate solvent typically used in this technical field. Preferably, the solvent may further comprise one or more organic carbonates, which can be fluorinated or non-fluorinated, linear or cyclic. Obviously, the component(s) of the solvent should be different from the fluorinated acyclic carbonate compound and from the fluorinated cyclic carbonate compound which are defined here as additive of the electrolyte composition according to the invention.

Suitable non-fluorinated cyclic organic carbonates can include, for example: ethylene carbonate (also known as 1,3-dioxalan-2-one); propylene carbonate; vinylene carbonate; ethyl propyl vinylene carbonate; vinyl ethylene carbonate; dimethylvinylene carbonate.

Suitable non-fluorinated acyclic organic carbonates can include, for example: ethyl methyl carbonate; dimethyl carbonate; diethyl carbonate; di-tert-butyl carbonate; dipropyl carbonate; methyl propyl carbonate; methyl butyl carbonate; ethyl butyl carbonate; propyl butyl carbonate; dibutyl carbonate.

Suitable fluorinated acyclic organic carbonates can include, for example: bis(2,2,3,3-tetrafluoropropyl) carbonate; bis(2,2,2-trifluoroethyl) carbonate; bis(2,2-difluoroethyl) carbonate; 2,3,3-trifluoroallyl methyl carbonate; or mixtures thereof.

It is desirable to use a carbonate that is battery grade or has a purity level of at least about 99.9%, for example at least about 99.99%. Organic carbonates are available commercially or may be prepared by methods known in the art.

According to one preferred embodiment, the solvent of the electrolyte composition comprises a non-fluorinated cyclic carbonate, which may be preferably selected from the group consisting of ethylene carbonate, propylene carbonate, and mixtures thereof. In one embodiment, the cyclic carbonate comprises ethylene carbonate. In one embodiment, the cyclic carbonate comprises propylene carbonate. The content of non-fluorinated cyclic carbonate may be comprised between 5 vol. % and 95 vol. %, preferably between 8 vol. % and 50 vol. %, more preferably between 10 vol. % and 30 vol. %, based on the total volume of the solvent.

According to another preferred embodiment, the solvent of the electrolyte composition comprises a non-fluorinated acyclic carbonate, which may be preferably selected from the group consisting of ethyl methyl carbonate, dimethyl carbonate, diethyl carbonate; and mixtures thereof. The content of non-fluorinated acyclic carbonate may be comprised between 5 vol. % and 95 vol. %, preferably between 50 vol. % and 92 vol. %, more preferably between 70 vol. % and 90 vol. %, based on the total volume of the solvent.

According to another preferred embodiment, the solvent of the electrolyte composition comprises at least one non-fluorinated cyclic carbonate and at least one non-fluorinated acyclic carbonate, for instance ethylene carbonate/ethyl methyl carbonate, ethylene carbonate/dimethyl carbonate, ethylene carbonate/diethyl carbonate, ethylene carbonate/ethyl methyl carbonate/dimethyl carbonate, ethylene carbonate/ethyl methyl carbonate/diethyl carbonate, propylene carbonate/ethyl methyl carbonate, propylene carbonate/dimethyl carbonate, propylene carbonate/diethyl carbonate, propylene carbonate/ethyl methyl carbonate/dimethyl carbonate, propylene carbonate/ethyl methyl carbonate/diethyl carbonate.

According to another embodiment, the solvent of the electrolyte composition comprises at least one non-fluorinated acyclic ester, for example ethyl acetate, ethyl propionate, propyl acetate, propyl propionate, and mixtures thereof.

According to another embodiment, the solvent of the electrolyte composition comprises at least one fluorinated acyclic ester, for example 2,2-difluoroethyl acetate, 2,2,2-trifluoroethyl acetate, 2,2-difluoroethyl propionate, 3,3-difluoropropyl acetate, 3,3-difluoropropyl propionate, and mixtures thereof.

The term “electrolyte salt” as used herein, refers to an ionic salt that is at least partially soluble in the solvent of the electrolyte composition and that at least partially dissociates into ions in the solvent of the electrolyte composition to form a conductive electrolyte composition.

The electrolyte compositions according to the present invention also comprise an electrolyte salt. Suitable electrolyte salts include without limitation:
lithium hexafluorophosphate (LiPF₆),
lithium difluorophosphate (LiPO₂F₂),
lithium bis(trifluoromethyl)tetrafluorophosphate (LiPF₄(CF₃)₂),
lithium bis(pentafluoroethyl)tetrafluorophosphate (LiPF₄(C₂F₅)₂),
lithium tris(pentafluoroethyl)trifluorophosphate (LiPF₃(C₂F₅)₃),
lithium bis(trifluoromethanesulfonyl)imide,
lithium bis(fluorosulfonyl)imide,
lithium bis(perfluoroethanesulfonyl)imide,
lithium (fluorosulfonyl)(nonafluorobutanesulfonyl)imide,
lithium tetrafluoroborate,
lithium perchlorate,
lithium hexafluoroarsenate,
lithium trifluoromethanesulfonate,
lithium tris(trifluoromethanesulfonyl)methide,
lithium bis(oxalato)borate,
lithium difluoro(oxalato)borate,
lithium difluoro bis(oxalato) phosphate,
Li₂B₁₂F₁₂₋ₓHₓ where x is equal to 0 to 8,
mixtures of lithium fluoride and anion receptors such as B(OC₆F₅)₃.

Mixtures of two or more of these or comparable electrolyte salts may also be used. According to a preferred embodiment, the electrolyte salt comprises lithium hexafluorophosphate LiPF₆. Alternatively, the electrolyte salt comprises lithium bis(trifluoromethanesulfonyl)imide LiTFSI. Alternatively, the electrolyte salt comprises lithium bis(fluorosulfonyl)imide LiFSI. The electrolyte salt can be present in the electrolyte composition in an amount from about 0.2 M to about 2.0 M, for example from about 0.3 M to about 1.7 M, or for example from about 0.5 M to about 1.2 M, or for example 0.5 M to about 1.7 M.

Optionally, the electrolyte composition according to the present invention may further comprise an additive such as a lithium boron compound, a cyclic sultone, a cyclic sulfate, a cyclic carboxylic acid anhydride, or a combination thereof.

In some embodiments, the electrolyte composition further comprises a lithium boron compound. Suitable lithium boron compounds include lithium terafluoroborate, lithium bis(oxalato)borate, lithium difluoro(oxalato)borate, other lithium boron salts, Li₂B₁₂F₁₂₋ₓHₓ, wherein x is 0 to 8, mixtures of lithium fluoride and anion receptors such as B(OC₆F₅)₃, or mixtures thereof. According to a preferred embodiment, the electrolyte composition of the invention additionally comprises at least one lithium borate salt selected from lithium bis(oxalato)borate, lithium difluoro(oxalato)borate, lithium tetrafluoroborate, or mixtures thereof, preferably lithium bis(oxalato)borate. The lithium borate compound may be present in the electrolyte composition in the range of from 0.1 wt. % to about 10 wt. %, based on the total weight of the electrolyte composition, for example in the range of from 0.1 wt. % to about 5.0 wt. %, or from 0.3 wt. % to about 4.0 wt. %, or from 0.5 wt. % to 2.0 wt. %. The lithium boron compounds can be obtained commercially or prepared by methods known in the art.

In some embodiments, the electrolyte composition further comprises a cyclic sultone. Suitable sultones include those represented by the formulas:

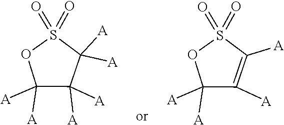

wherein each A is independently a hydrogen, fluorine, or an optionally fluorinated alkyl, vinyl, allyl, acetylenic, or propargyl group. The vinyl (H₂C═CH—), allyl (H₂C═CH—CH₂—), acetylenic (HC≡C—), or propargyl (HC≡C—CH₂—) groups may each be unsubstituted or partially or totally fluorinated. Each A can be the same or different as one or more of the other A groups, and two or three of the A groups can together form a ring. Mixtures of two or more of sultones may also be used. Suitable sultones include 1,3-propane sultone, 1,3-propene sultone, 3-fluoro-1,3-propane sultone, 4-fluoro-1,3-propane sultone, 5-fluoro-1,3-propane sultone, and 1,8-naphthalenesultone. According to a preferred embodiment, the sultone comprises 1,3-propane sultone, 1,3-propene sultone or 3-fluoro-1,3-propane sultone, preferably 1,3-propane sultone or 1,3-propene sultone.

In one embodiment the sultone is present at about 0.01 wt. % to about 10 wt. %, or about 0.1 wt. % to about 5 wt. %, or about 0.5 wt. % to about 3 wt. %, or about 1 wt. % to about 3 wt. % or about 1.5 wt. % to about 2.5 wt. %, or about 2 wt. %, of the total electrolyte composition.

In some embodiments, the electrolyte composition further comprises a cyclic sulfate. Suitable cyclic sulfates include those represented by the formula:

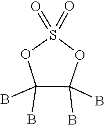

wherein each B is independently a hydrogen or an optionally fluorinated vinyl, allyl, acetylenic, propargyl, or C₁-C₃ alkyl group. The vinyl (H₂C═CH—), allyl (H₂C═CH—CH₂—), acetylenic (HC≡C—), propargyl (HC≡C—CH₂—), or C₁-C₃ alkyl groups may each be unsubstituted or partially or totally fluorinated. Mixtures of two or more of cyclic sulfates may also be used. Suitable cyclic sulfates include ethylene sulfate (1,3,2-dioxathiolane-2,2-dioxide), 1,3,2-dioxathiolane-4-ethynyl-2,2-dioxide, 1,3,2-dioxathiolane-4-ethenyl-2,2-dioxide, 1,3,2-dioxathiolane-4,5-diethenyl-2,2-dioxide, 1,3,2-dioxathiolane-4-methyl-2,2-dioxide, and 1,3,2-dioxathiolane-4,5-dimethyl-2,2-dioxide. According to a preferred embodiment, the cyclic sulfate is ethylene sulfate.

In one embodiment, the cyclic sulfate is present at about 0.1 wt. % to about 12 wt. % of the total electrolyte composition, or about 0.5 wt. % to less than about 10 wt. %, about 0.5 wt. % to less than about 5 wt. %, or about 0.5 wt. % to about 3 wt. %, or about 0.5 wt. % to about 2 wt. %, or about 2 wt. % to about 3 wt. %. In one embodiment the cyclic sulfate is present at about 1 wt. % to about 3 wt. % or about 1.5 wt. % to about 2.5 wt. %, or about 2 wt. % of the total electrolyte composition.

In some embodiments, the electrolyte composition further comprises a cyclic carboxylic acid anhydride. Suitable cyclic carboxylic acid anhydrides include those selected from the group consisting of the compounds represented by Formula (IV) through Formula (XI):

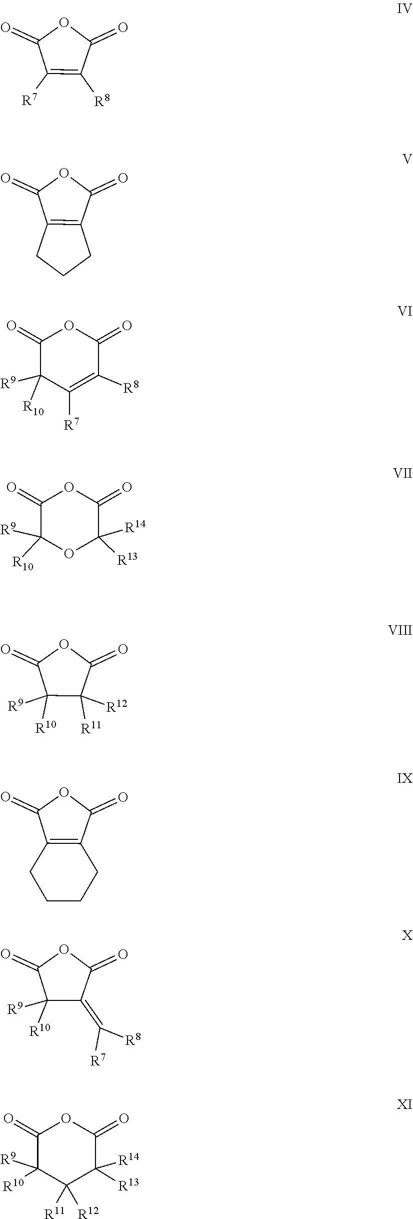

wherein R⁷ to R¹⁴ is each independently H, F, a linear or branched C₁ to C₁₀ alkyl radical optionally substituted with F, alkoxy, and/or thioalkyl substituents, a linear or branched C₂ to C₁₀ alkenyl radical, or a C₆ to C₁₀ aryl radical. The alkoxy substituents can have from one to ten carbons and can be linear or branched; examples of alkoxy substituents include —OCH₃, —OCH₂CH₃, and —OCH₂CH₂CH₃. The thioalkyl substituents can have from one to ten carbons and can be linear or branched; examples of thioalkyl substituents include —SCH₃, —SCH₂CH₃, and —SCH₂CH₂CH₃. Examples of suitable cyclic carboxylic acid anhydrides include maleic anhydride; succinic anhydride; glutaric anhydride; 2,3-dimethylmaleic anhydride; citraconic anhydride; 1-cyclopentene-1,2-dicarboxylic acid anhydride; 2,3-diphenylmaleic anhydride; 3,4,5,6-tetrahydrophthalic anhydride; 2,3-dihydro-1,4-dithiiono-[2,3-c] furan-5,7-dione; and phenylmaleic anhydride. A mixture of two or more of these cyclic carboxylic acid anhydrides can also be used. According to a preferred embodiment, the cyclic carboxylic acid anhydride comprises maleic anhydride. In one embodiment, the cyclic carboxylic acid anhydride comprises maleic anhydride, succinic anhydride, glutaric anhydride, 2,3-dimethylmaleic anhydride, citraconic anhydride, or mixtures thereof. Cyclic carboxylic acid anhydrides can be obtained from a specialty chemical company such as Sigma-Aldrich, Inc. (Milwaukee, Wis.), or prepared using methods known in the art. It is desirable to purify the cyclic carboxylic acid anhydride to a purity level of at least about 99.0%, for example at least about 99.9%. Purification can be done using methods known in the art.

In some embodiments, the electrolyte composition comprises about 0.1 wt. % to about 5 wt. % of the cyclic carboxylic acid anhydride, based on the total weight of the electrolyte composition.

Optionally, the electrolyte compositions according to the invention can further comprise additives that are known to those of ordinary skill in the art to be useful in conventional electrolyte compositions, particularly for use in lithium ion batteries. For example, electrolyte compositions disclosed herein can also include gas-reduction additives which are useful for reducing the amount of gas generated during charging and discharging of lithium ion batteries. Gas-reduction additives can be used in any effective amount, but can be included to comprise from about 0.05 wt. % to about 10 wt. %, preferably from about 0.05 wt. % to about 5 wt. %, more preferably from about 0.5 wt. % to about 2 wt. %, of the electrolyte composition.

Suitable gas-reduction additives that are known conventionally are, for example: halobenzenes such as fluorobenzene, chlorobenzene, bromobenzene, iodobenzene, or haloalkylbenzenes; 1,3-propane sultone; succinic anhydride; ethynyl sulfonyl benzene; 2-sulfobenzoic acid cyclic anhydride; divinyl sulfone; triphenylphosphate (TPP); diphenyl monobutyl phosphate (DMP); γ-butyrolactone; 2,3-dichloro-1,4-naphthoquinone; 1,2-naphthoquinone; 2,3-dibromo-1,4-naphthoquinone; 3-bromo-1,2-naphthoquinone; 2-acetylfuran; 2-acetyl-5-methylfuran; 2-methyl imidazole1-(phenylsulfonyl)pyrrole; 2,3-benzofuran; fluoro-cyclotriphosphazenes such as 2,4,6-trifluoro-2-phenoxy-4,6-dipropoxy-cyclotriphosphazene and 2,4,6-trifluoro-2-(3-(trifluoromethyl)phenoxy)-6-ethoxy-cyclotriphosphazene; benzotriazole; perfluoroethylene carbonate; anisole; diethylphosphonate; fluoroalkyl-substituted dioxolanes such as 2-trifluoromethyldioxolane and 2,2-bistrifluoromethyl-1,3-dioxolane; trimethylene borate; dihydro-3-hydroxy-4,5,5-trimethyl-2(3H)-furanone; dihydro-2-methoxy-5,5-dimethyl-3(2H)-furanone; dihydro-5,5-dimethyl-2,3-furandione; propene sultone; diglycolic acid anhydride; di-2-propynyl oxalate; 4-hydroxy-3-pentenoic acid γ-lactone; CF₃COOCH₂C(CH₃)(CH₂OCOCF₃)₂; CF₃COOCH₂CF₂CF₂CF₂CF₂CH₂OCOCF₃; α-methylene-γ-butyrolactone; 3-methyl-2(5H)-furanone; 5,6-dihydro-2-pyranone; diethylene glycol, diacetate; triethylene glycol dimethacrylate; triglycol diacetate; 1,2-ethanedisulfonic anhydride; 1,3-propanedisulfonic anhydride; 2,2,7,7-tetraoxide 1,2,7-oxadithiepane; 3-methyl-2,2,5,5-tetraoxide 1,2,5-oxadithiolane; hexamethoxycyclotriphosphazene; 4,5-dimethyl-4,5-difluoro-1,3-dioxolan-2-one; 2-ethoxy-2,4,4,6,6-pentafluoro-2,2,4,4,6,6-hexahydro-1,3,5,2,4,6-triazatriphosphorine; 2,2,4,4,6-pentafluoro-2,2,4,4,6,6-hexahydro-6-methoxy-1,3,5,2,4,6-triazatriphosphorine; 4,5-difluoro-1,3-dioxolan-2-one; 1,4-bis(ethenylsulfonyl)-butane; bis(vinylsulfonyl)-methane; 1,3-bis(ethenylsulfonyl)-propane; 1,2-bis(ethenylsulfonyl)-ethane; ethylene carbonate; diethyl carbonate; dimethyl carbonate; ethyl methyl carbonate; and 1,1′-[oxybis(methylenesulfonyl)]bis-ethene.

Optionally, the electrolyte compositions according to the invention can further comprise additives that are known as film-forming additives. Film-forming additives may be able to promote the formation of the solid electrolyte interface SEI layer at the anode surface and/or cathode surface by reacting in advance of the solvents on the electrode surfaces. Main components of SEI hence comprise the decomposed products of electrolyte solvents and salts, which include Li₂CO₃, lithium alkyl carbonate, lithium alkyl oxide and other salt moieties such as LiF for LiPF₆-based electrolytes. Usually, the reduction potential of the film-forming additive is higher than that of solvent when reactions occurs at the anode surface, and the oxidation potential of the film-forming additive is lower than that of solvent when reaction occurs at the cathode side. In the present invention, the film-forming additive is not typically a fluorinated compound. Examples of film-forming additives include, but not limited to, salts based on tetrahedral boron compounds comprising lithium(bisoxalatoborate) and lithium difluorooxalato borate; cyclic sulphites and sulfate compounds comprising 1,3-propanesultone, ethylene sulphite and prop-1-ene-1,3-sultone; sulfone derivatives comprising dimethyl sulfone, tetrametylene sulfone (also known as sulfolane), ethyl methyl sulfone and isopropyl methyl sulfone; nitrile derivatives comprising succinonitrile, adiponitrile glutaronitirle and 4,4,4- trifluoronitrile; and vinyl acetate, biphenyl benzene, isopropyl benzene, hexafluorobenzene, lithium nitrate (LiNO₃), tris(trimethylsilyl)phosphate, triphenyl phosphine, ethyl diphenylphosphinite, triethyl phosphite, vinylene carbonate, vinyl ethylene carbonate, ethyl propyl vinylene carbonate, dimethyl vinylene carbonate, maleic anhydride, and mixtures thereof. The total amount of all the film-forming additive(s) generally accounts for from 0.05 wt. % to 30 wt. %, preferably from 0.05 wt;% to 20 wt. %, more preferably from 2 wt. % to 15 wt. %, and even more preferably from 2 wt. % to 5 wt. %, based on the total weight of the electrolyte composition.

Other suitable additives that can be used are HF scavengers, such as silanes, silazanes (Si—NH—Si), epoxides, amines, aziridines (containing two carbons), salts of carbonic acid lithium oxalate, B₂O₅, ZnO, and fluorinated inorganic salts.

The electrochemical cell as disclosed herein can be used in a variety of applications. It may be used as an energy storage device. An “energy storage device” is a device that is designed to provide electrical energy on demand, such as a battery or a capacitor. Energy storage devices contemplated herein at least in part provide energy from electrochemical sources. For example, the electrochemical cell can be used for grid storage or as a power source in various electrically powered or assisted devices, such as, a computer, a camera, a radio, a power tool, a telecommunication device, or a transportation device. The present disclosure also relates to an electronic device, a telecommunication device, or a transportation device comprising the disclosed electrochemical cell.

Unexpectedly, the inventors discovered that the combination of a fluorinated acyclic carbonate compound with a fluorinated cyclic carbonate as defined in the present invention provides more than the simple combination of the effect of both compounds. The inventors discovered that said combination provide synergistic effect on the performances on an electrochemical cell with silicon containing anode. Another subject-matter of the present invention is the use of a combination of:
from 0.5 wt. % to 70 wt. %, based on the total weight of the electrolyte, of a fluorinated acyclic carbonate compound of general formula

R¹—OCOO—R²

wherein R¹ is a C1-C4 alkyl group, and R² is C1-C4 fluoroalkyl group,
from 0.5 wt. % to 10 wt. %, based on the total weight of the electrolyte, of a fluorinated cyclic carbonate compound,
as additive in an electrolyte composition, to improve the cycling performance at high temperature of an electrochemical cell comprising, as anode active material, a combination of at least a carbon material and a silicon material.

Should the disclosure of any patents, patent applications, and publications which are incorporated herein by reference conflict with the description of the present application to the extent that it may render a term unclear, the present description shall take precedence.

The examples which follow serve to illustrate the invention in more detail but do not constitute a limitation thereof.

### Examples

Materials and Methods

EC: ethylene carbonate—battery grade, purchased from Panax ETEC Co. Ltd., Korea
EMC: ethyl methyl carbonate—battery grade, purchased from Enchem Co. Ltd., Korea
FEC: fluoroethylene carbonate—battery grade, purchased from Enchem Co. Ltd., Korea
TFEMC: trifluoroethyl methyl carbonate (CH₃—OC(O)O—CH₂CF₃)—synthetized by Solvay.

Cathodes and anodes were produced by UTP (Ulsan Techno Park, Korea):
NCA cathode (LiNiCoAlO₂ from Ecopro, Korea)
graphite-silicon composite anode (Si/C from BTR New Energy Materials Inc., China).

Electrolyte Preparation

The electrolyte composition was prepared as follows. A stock solution of EC/EMC 30/70 (v/v) solution was prepared in an argon purged dry box. LiPF₆ was added in order to reach a concentration of 1 M. FEC and TFEMC were added in order to reach the concentrations mentioned in Table 1 herein below. The mixture was gently agitated to dissolve the components.

TABLE 1

| | Salt | Solvent (v/v) | | Additives (wt. %^{a}) | |
|---|---|---|---|---|---|
| | LiPF | EC | EMC | TFEMC | FEC |
| EL1 | 1M | 30 | 70 | — | 5 |
| EL2 | 1M | 30 | 70 | 5 | — |
| EL3 | 1M | 30 | 70 | 2.5 | 2.5 |

^{a}weight percent, relative to the total weight of the electrolyte composition.

Coin Cells Preparation

Coin cells were prepared by using electrodes of pouch cells purchased from UTP, with an NCA cathode and a Si/C anode. The electrodes were punched in air, then heated overnight at 100° C. under vacuum to remove residual moisture, and then transferred into the glove box where the coin cells were assembled by using cathode, anode and polyethylene separator in between. The same volume of electrolyte was used for all of the coin cells.

Coin Cell Evaluation Procedure

Cycling at 25° C.: Cells were maintained at 25±0.1° C. and cycled at 1C charge/2C discharge between 2.7 and 4.2V.

Cycling at 45° C.: Cells were maintained at 45±0.1° C. and cycled at 1C charge/2C discharge between 2.7 and 4.2V.

Storage test: Cells were charged to 4.2 V and were transferred to thermal chamber for storage test. Cells were kept at 60° C. for 3 days and capacity retention and recovery were measured.

Results

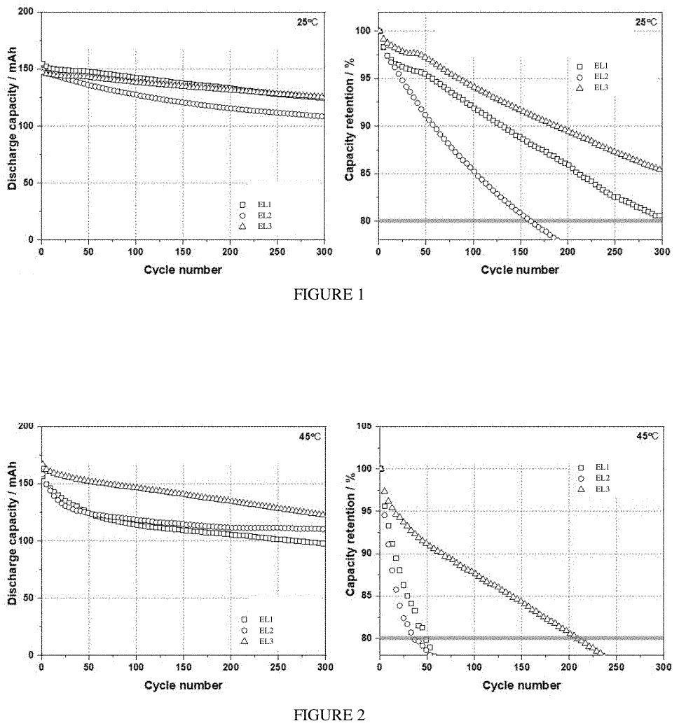

The cycling performance of the electrolyte formulations at room temperature (25° C.) and the cycling performance of the electrolyte formulations at high temperature (45° C.) is shown on FIG. 1 and FIG. 2, and on Table 2:

TABLE 2

| | Capacity retention at 25° C. | | | Capacity retention at 45° C. | | |
|---|---|---|---|---|---|---|
| | 100^{th} cycle | 200^{th} cycle | 300^{th} cycle | 100^{th} cycle | 200^{th} cycle | 300^{th} cycle |
| EL1 | 92.1% | 86.1% | 80.5% | 72.9% | 67.6% | 62.3% |
| EL2 | 85.5% | 77.3% | 72.5% | 74.9% | 70.5% | 69.7% |
| EL3 | 94.1% | 89.5% | 85.0% | 87.6% | 80.7% | 73.2% |

At room temperature (25° C.) as well as at high temperature (45° C.), the formulation containing the combination of FEC and TFEMC according to the invention (EL3) shows unexpected good cycling performance when compared to electrolyte formulations containing FEC only (EL1) or TFEMC only (EL2). Especially at high temperature, after 300 cycles, the performance of the cell containing the formulation according to the invention (EL3) is significantly improved versus the cell containing a formulation with FEC only (EL1).

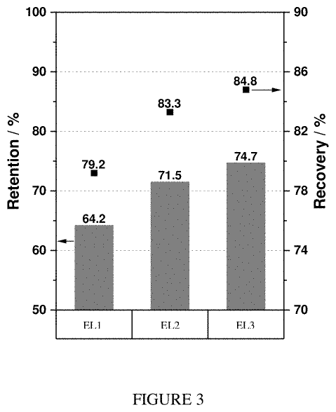

The storage performance of electrolyte formulations is shown on FIG. 3.

The formulation containing the combination of FEC and TFEMC according to the invention (EL3) shows higher capacity retention and recovery after storage test at 60° C. for 3 days when compared to electrolyte formulations containing FEC only (EL1) or TFEMC only (EL2).

1. An electrochemical cell comprising an anode, a cathode and an electrolyte composition, wherein said anode comprises as an anode active material a combination of at least a carbon material and a silicon material; and said electrolyte composition comprises:
a solvent;
from 0.5 wt. % to 70 wt. %, based on the total weight of the electrolyte, of a fluorinated acyclic carbonate compound of general formula
R1—OCOO—R2
wherein R1 is a C1-C4 alkyl group, and R2 is C1-C4 fluoroalkyl group,
from 0.5 wt. % to 10 wt. %, based on the total weight of the electrolyte, of a fluorinated cyclic carbonate compound; and
an electrolyte salt.

2. The electrochemical cell according to claim 1, wherein the anode is a composite material selected from Si/C, SiOa/C and Si/SiOa/C, with 0<a<2.

3. The electrochemical cell according to claim 1, wherein said fluorinated acyclic carbonate is selected from the group consisting of methyl 2,2-difluoroethyl carbonate, methyl 2,2,2-trifluoroethyl carbonate, methyl 2,2,3,3-tetrafluoropropyl carbonate, ethyl 2,2-difluoroethyl carbonate, ethyl 2,2,2-trifluoroethyl carbonate, and mixtures thereof.

4. The electrochemical cell according to claim 3, wherein said fluorinated acyclic carbonate is methyl 2,2,2-trifluoroethyl carbonate.

5. The electrochemical cell according to claim 3, wherein said fluorinated acyclic carbonate is methyl 2,2-difluoroethyl carbonate.

6. The electrochemical cell according to claim 1, wherein the content of the fluorinated acyclic carbonate compound is from 0.5 wt. % to 10 wt. %, based on the total weight of the electrolyte.

7. The electrochemical cell according to claim 1, wherein said fluorinated cyclic carbonate is selected from the group consisting of 4-fluoroethylene carbonate, 4,5-difluoro-1,3-dioxolan-2-one, 4,5-difluoro-4-methyl-1,3-dioxolan-2-one, 4,5-difluoro-4,5-dimethyl-1,3-dioxolan-2-one, 4,4-difluoro-1,3-dioxolan-2-one, 4,4,5-trifluoro-1,3-dioxolan-2-one, tetrafluoroethylene carbonate, and mixtures thereof.

8. The electrochemical cell according to claim 1, wherein the content of the fluorinated cyclic carbonate compound is from 1 wt. % to 9 wt. %.

9. The electrochemical cell according to claim 1, wherein the solvent of the electrolyte composition comprises a non-fluorinated cyclic carbonate.

10. The electrochemical cell according to claim 1, wherein the solvent of the electrolyte composition comprises a non-fluorinated acyclic carbonate.

11. The electrochemical cell according to claim 1, wherein the electrolyte composition further comprises an additive selected from a lithium boron compound, a cyclic sultone, a cyclic sulfate, a cyclic carboxylic acid anhydride, or a combination thereof.

12. An electronic device, transportation device, or telecommunications device, comprising an electrochemical cell according to claim 1.

13. A method of improving cycling performance at high temperature of an electrochemical cell comprising an anode and an electrolyte composition, wherein said anode comprises, as an anode active material, a combination of at least a carbon material and a silicon material, the method comprising:
adding an additive to the electrolyte composition, the additive comprising:
from 0.5 wt. % to 70 wt. %, based on the total weight of the electrolyte, of a fluorinated acyclic carboxylic acid ester compound of general formula
R¹—COO—R²
wherein R¹ is a C1-C4 alkyl group, and R² is C1-C4 fluoroalkyl group, and
from 0.5 wt. % to 10 wt. %, based on the total weight of the electrolyte, of a fluorinated cyclic carbonate compound.

14. The electrochemical cell according to claim 9, wherein the non-fluorinated cyclic carbonate is selected from the group consisting of ethylene carbonate, propylene carbonate, and mixtures thereof.

15. The electrochemical cell according to claim 10, wherein the non-fluorinated acyclic carbonate is selected from the group consisting of ethyl methyl carbonate, dimethyl carbonate, diethyl carbonate; and mixtures thereof.

16. The electrochemical cell according to claim 6, wherein the content of the fluorinated acyclic carbonate compound is from 2 wt. % to 5 wt. %, based on the total weight of the electrolyte.

17. The electrochemical cell according to claim 7, wherein said fluorinated cyclic carbonate is selected from the group consisting of 4-fluoroethylene carbonate, 4,5-difluoro-1,3-dioxolan-2-one, and mixtures thereof.

18. The electrochemical cell according to claim 8, wherein the content of the fluorinated cyclic carbonate compound is from 2 wt. % to 5 wt. %.
